(19) United States
(12) Patent Application Publication
(10) Pub. No.: US 2025/0127184 A1
(43) Pub. Date: Apr. 24, 2025

(54) METHOD AND APPARATUS

(71) Applicant: Kraft Foods Schweiz Holding GmbH, Zug (CH)

(72) Inventors: Emma McLeod, Bournville (GB); Anna Osborne, Bournville (GB)

(21) Appl. No.: 18/038,867

(22) PCT Filed: Nov. 29, 2021
(86) PCT No.: PCT/EP2021/083323

§ 371 Date: May 25, 2023

(30) Foreign Application Priority Data
Nov. 30, 2020 (GB) 2018855.3

(51) Int. Cl. A23G 1/00; A23G 1/18; A23G 3/02; A23G 3/34; G05B 13/04

(52) U.S. Cl. CPC A23G 1/0046; A23G 1/18; G05B 13/048; A23G 3/0014; A23G 3/0226

(57) ABSTRACT

A method of predicting a temper level and/or a viscosity of a tempered mass, provided by tempering of a fat-containing, crystallisable mass, for example a chocolate mass, by flowing the mass successively through a temperer comprising an inlet, a crystallization stage to form crystals therein and a reheat stage to melt unstable crystals formed therein, is described. The method is implemented, at least in part, by a computer including a processor and a memory. The method comprises predicting the temper level and/or the viscosity of the tempered mass using a model, wherein the model relates the temper level and/or the viscosity of the tempered mass to one or more temperer process parameters. A method of controlling tempering and a temperer are also described.

### FIELD

The present invention relates to tempering of fat-containing, crystallisable masses, for example chocolate masses.

### BACKGROUND TO THE INVENTION

Cocoa butter comprises a mixture of triacylglycerols. Symmetrical monounsaturated triacylglycerols, also known as saturated unsaturated saturated triacylglycerols (SUS), predominate and define tempering and sensorial characteristics of chocolate products. Usually, the fatty acid profile of cocoa butter includes oleic (O), stearic (St) and palmitic (P) acids in ranges of about 32.5 to 36.5 wt. %, about 33.0 to 37.5 wt. % and about 24.0 to 28.0 wt. %, respectively. POP (1-palmitoyl-2-oleoyl-palmitin), StOSt (1-stearyl-2-oleoyl-stearin) and POSt (1-palmitoyl-2-oleoyl-stearin) are the principal triacylglycerols for cocoa butter. Hence, these particular symmetrical triacylglycerols comprise about 79 wt. % to 89 wt. % of cocoa butter. Importantly, the unique crystal packing characteristics and hence polymorphs of these triacylglycerols affect crystallization behaviour, thereby defining the tempering and sensorial characteristics of chocolate products, as summarised in Table 1.

TABLE 1
Polymorphs of triacylglycerols. Stability and density
of the polymorphs increases from Form I to Form VI.

| Polymorph | Melting point (° C.) | Comment |
|---|---|---|
| Form I (γ) | 17.3 | Soft and crumbly with |
| | | noticeable blooming. Formed |
| | | by rapid cooling below 0° C. |
| Form II (α) | 23.3 | Soft and crumbly with |
| | | noticeable blooming. Maybe |
| | | formed by cooling at 2° C. per |
| | | minute. Also formed from |
| | | Form I after storage at below |
| | | 0° C. |
| Form III (β′) | 25.5 | Firm but without good snap |
| | | and may show some |
| | | blooming. Formed by cooling |
| | | at 5 to 10° C. Also formed |
| | | from Form II after storage at |
| | | low temperatures |
| Form IV (β′) | 27.3 | Firm but without good snap |
| | | and may show some |
| | | blooming. Formed by |
| | | allowing melted chocolate to |
| | | cool at room temperature. |
| | | Also formed from Form III |
| | | after storage at room |
| | | temperature. |
| Form V (β) | 33.8 | Shiny, smooth texture, |
| | | increased resistance to heat, |
| | | good moulding properties, |
| | | good snap and melts in the |
| | | mouth, not in the hand. Most |
| | | desirable polymorph. |
| Form VI (β) | 36.3 | Hard and melts slowly in the |
| | | mouth, shows some |
| | | blooming. Not formed from |
| | | melted chocolate. Forms |
| | | upon storage of Form V. |

Natural cooling of melted cocoa butter results in a mixture of Forms I to V. However, Forms I to IV are less desirable, adversely affecting the quality of the chocolate. Hence, the goal of tempering is to increase the fraction of the desirable Form V polymorph, preferably to avoid the undesirable Forms I to IV. Tempering typically comprises:
i. heating a chocolate mass to a temperature such that all the polymorphs melt;
ii. cooling the melted chocolate mass very slowly, so as to initiate nucleation and growth of predominantly Form V polymorph crystals; and
iii. reheating the cooled, recrystallised chocolate mass to below the melting point of the Form V polymorph, so as to melt the undesirable Forms I to IV.

During subsequent cooling of the reheated chocolate mass, for example to produce chocolate products, the Form V crystals grow such that the fraction of Forms I to IV remaining is residual. While Form V is the most desirable polymorph, it is also metastable, transforming to Form VI upon storage, for example over several months, but maybe avoided by storage at relatively low temperatures.

However, depending on the variety, origin, seasonality and also handling techniques of cocoa, the triacylglycerol composition may vary, as generally occurs with natural vegetable fats and oils. This natural variability of ingredients may result in batch-to-batch variability of the tempered chocolate mass, such that some batches fail to meet quality criteria and/or further tempering is required, thereby increasing wastage and/or reducing process efficiency such that throughput is decreased.

Furthermore, tempering is a complex process and the tempering conditions are difficult to control in large scale production. Tempering is also an energetically costly process, due to repeated heating and cooling of the mass.

Hence, there is a need to improve tempering fat-containing, crystallisable masses, for example chocolate masses, for example so as to improve batch-to-batch variability while increasing throughput.

### SUMMARY OF THE INVENTION

It is one aim of the present invention, amongst others, to provide a method and/or a temperer which at least partially obviate or mitigate at least some of the disadvantages of the prior art, whether identified herein or elsewhere. For instance, it is an aim of embodiments of the invention to provide a method of predicting a temper level and/or a viscosity of a tempered mass that enables improved control of tempering, for example online or in real-time. For instance, it is an aim of embodiments of the invention to provide a method of controlling tempering of a fat-containing, crystallisable mass that improve batch-to-batch variability and/or increases throughput. For instance, it is an aim of embodiments of the invention to provide a temperer for tempering of a fat-containing, crystallisable mass that improve batch-to-batch variability and/or increases throughput.

A first aspect provides a method of predicting a temper level and/or a viscosity of a tempered mass provided by tempering of a fat-containing, crystallisable mass, for example a chocolate mass, by flowing the mass successively through a temperer comprising an inlet, a crystallization stage to form crystals therein and a reheat stage to melt unstable crystals formed therein, the method implemented, at least in part, by a computer including a processor and a memory, the method comprising:
predicting the temper level and/or the viscosity of the tempered mass using a model, wherein the model relates the temper level and/or the viscosity of the tempered mass to one or more temperer process parameters.

A second aspect provides a method of controlling tempering of a fat-containing, crystallisable mass, for example a chocolate mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or temperer process parameters;
predicting a temper level and/or a viscosity of a tempered mass according to the first aspect using the sensed one or more temperer process parameters;
comparing the predicted temper level with a target temper level range and/or comparing the predicted viscosity with a target viscosity range; and
controlling one or more set points of temperer process parameters, based on a result of the comparing.

A third aspect provides a temperer for tempering of a fat-containing, crystallisable mass, for example a chocolate mass, the temperer comprising:
an inlet, a crystallization stage and a reheat stage defining a flowpath therethrough for the mass;
a set of sensors for sensing one or more temperer process parameters; and
a computer, including a processor and a memory, configured to:
predict a temper level and/or a viscosity of the tempered mass using a model, wherein the model relates the temper level and/or the viscosity of the tempered mass to the sensed one or more temperer process parameters;
compare the predicted temper level with a target temper level range and/or compare the predicted viscosity with a target viscosity range; and
control one or more set points of the temperer process parameters of the inlet, the crystallization stage and/or the reheat stage, based on a result of the comparing.

A fourth aspect provides a method of controlling tempering of a fat-containing, crystallisable mass, for example a chocolate mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or more temperer process parameters;
optimising a temper level and/or a viscosity of the tempered mass by controlling one or more set points of the temperer process parameters using a model of response dynamics of the tempering.

A fifth aspect provides a computer comprising a processor and a memory configured to implement a method according to the first aspect, the second aspect and/or the fourth aspect.

A sixth aspect provides a computer program comprising instructions which, when executed by a computer comprising a processor and a memory, cause the computer to perform a method according to the first aspect, the second aspect and/or the fourth aspect.

A seventh aspect provides a non-transient computer-readable storage medium comprising instructions which, when executed by a computer comprising a processor and a memory, cause the computer to perform a method according to the first aspect, the second aspect and/or the fourth aspect.

### DETAILED DESCRIPTION OF THE INVENTION

According to the present invention there is provided is a method, as set forth in the appended claims. Also provided is an apparatus. Other features of the invention will be apparent from the dependent claims, and the description that follows.

### Method of Predicting Temper Level and/or Viscosity of a Tempered Mass

The first aspect provides a method of predicting a temper level and/or a viscosity of a tempered mass provided by tempering of a fat-containing, crystallisable mass, for example a chocolate mass, by flowing the mass successively through a temperer comprising an inlet, a crystallization stage to form crystals therein and a reheat stage to melt unstable crystals formed therein, the method implemented, at least in part, by a computer including a processor and a memory, the method comprising:
predicting the temper level and/or the viscosity of the tempered mass using a model, wherein the model relates the temper level and/or the viscosity of the tempered mass to one or more temperer process parameters.

Particularly, the inventors have identified that the temper level and/or the viscosity of the tempered mass may be predicted from one or more temperer process parameters of the tempering of the mass, as described below in more detail. Importantly, the temper level and/or the viscosity of the tempered mass define, at least in part, a quality of the tempered mass. Hence, using the predicted temper level and/or the predicted viscosity of the tempered mass, the tempering may be controlled to maintain the temper level and/or the viscosity of the tempered mass within target ranges and/or at target values, for example in real-time. In this way, natural variability of ingredients (i.e. composition variability) may be responsively accounted for during the tempering, thereby improving batch-to-batch variability and/or increasing throughput, while enhancing quality of the tempered mass and/or reducing or eliminating bloom. Additionally and/or alternatively, mass (for example liquid chocolate) process variability, for example temperature and/or particle size due to changes in the mass making process and/or storage conditions may be responsively accounted for during the tempering, thereby improving batch-to-batch variability and/or increasing throughput, while enhancing quality of the tempered mass and/or reducing or eliminating bloom. Additionally and/or alternatively, perturbations to the tempering due to external factors, such as changes to ambient temperature, may be responsively accounted for during the tempering. By maintaining the temper level and/or the viscosity of the tempered mass within target ranges and/or at target values, downstream processing of the tempered product may be improved. For example, a relatively lower viscosity of the tempered mass may be targeted for moulding and/or coating. For example, a relatively higher viscosity of the tempered mass may be targeted to form thick, robust shell products, for example large hollow eggs, rabbits, Santas, etc.

### Quality of Chocolate

Generally, textural properties of chocolate include:
1. hardness in the mouth: the strength required to break off chocolate with the teeth and tongue;
2. meltability: the way in which chocolate melts completely in the mouth;
3. smoothness: the degree of roughness or grittiness experienced when chocolate melts in the mouth;
4. stickiness: the degree to which the mixture of melted chocolate and saliva sticks to the tongue and palate.

These textural properties contribute, at least in part, to a quality of the chocolate. Hence, by improving one or more of these textural properties, the quality of the chocolate may be, in turn, improved. For example, the hardness and/or meltability and hence quality of the chocolate may be improved by tempering the chocolate mass to a desired temper level.

### Temper Level

The method comprises predicting the temper level and/or the viscosity of the tempered mass using the model, wherein the model relates the temper level and/or the viscosity of the tempered mass to one or more temperer process parameters.

The temper level characterises the respective proportions of the different polymorphs of the fats in the tempered mass and may be used as a measure of the quality of stable crystals that are present therein. Typically, there is only about 1% solid fat in tempered chocolate so depending on the fat system, the crystals do not substantially influence the viscosity unless the chocolate is particularly prone to thickening. Tempered chocolate mass is usually relatively cooler than the warm chocolate mass that goes into the temperer and this lower relatively temperature may substantially influence viscosity.

In one example, the temper level comprises and/or is a temper index and/or a crystallization temperature of the tempered mass. In one example, predicting the temper level and/or the viscosity of the tempered mass using the model comprises predicting a temper index and/or a crystallization temperature of the tempered mass and/or the viscosity of the tempered mass using the model.

The crystallization temperature of the tempered mass may be measured using differential scanning calorimetry (DSC), for example using a Mettler Toledo DSC 3 or a DSC 3+ (Zurich, Switzerland) operated according to manufacturer's instructions such as using a DSC30 pan (aluminium standard 40 μl, hermetically sealed), sample weight about 10 to 20 mg cut from the tempered mass with a sharp knife and transferred to the pan without warming (avoiding heat from hands) and heating in the DSC to 60° C. at a rate of 10° C. min⁻¹. DSC may be used to also infer the relative proportions of polymorphs present.

The temper index (TI) may be measured using a tempermeter, for example a SOLLICH KG E6Tempermeter (Bad Salzuflen, Germany) or a Bühler Group MultiTherm tempermeter (Uzwil, Switzerland), operated according to manufacturer's instructions. A tempermeter cools the sample at a controlled rate while the temperature is measured using a temperature probe inside the sample. The cooling curve of well-tempered chocolate, for example, exhibits a plateau corresponding with crystallization of the triacylglycerols. If the triacylglycerols are under-tempered, unstable polymorphs crystallise at relatively lower temperatures (i.e. an undercooling), causing a rise in temperature. Conversely, if the triacylglycerols are over-tempered, crystallization begins at relatively higher temperatures such that relatively less heat is released at relatively low temperatures. The TI of a well-tempered chocolate is 5.0±0.1 (according to the MultiTherm tempermeter built-in algorithm). By the same algorithm, the TI for under-tempered and over-tempered chocolate are approximately 3.0±0.1 and 6.0±0.1, respectively. Other scales may be used for the TI. However, it should be understood that a target TI for a tempered mass may depend on the particular composition of the mass and/or subsequent processing of the tempered mass and hence, a target TI range and/or a target TI may correspond with well-tempered, under-tempered or over-tempered. That is, it may be important to predict the TI and control the tempering accordingly, so as to achieve a desired TI of the tempered mass.

Generally, for chocolate, if more than 3.0 wt. % of the cocoa butter is in a solid state, the chocolate mass becomes over-tempered. This makes demoulding very difficult, as the tempered chocolate mass does not contract sufficiently, and may also be associated with higher fat bloom potential. Conversely, if less than 1.0 wt. % of the cocoa butter is in a solid state, the chocolate mass becomes under-tempered, such that the tempered chocolate mass has a higher hardness than desired.

In one example, the model relates the temper level of the tempered mass to one or more physical, chemical and/or rheological properties of the tempered mass.

In one example, the one or more physical, chemical and/or rheological properties of the tempered mass include an absorption spectrum and/or a viscosity.

### Viscosity

The method comprises predicting the temper level and/or the viscosity of the tempered mass using the model, wherein the model relates the temper level and/or the viscosity of the tempered mass to one or more temperer process parameters.

In one example, predicting the temper level and/or the viscosity of the tempered mass using the model comprises predicting the viscosity of the tempered mass using the model, wherein the predicted viscosity of the tempered mass corresponds with a viscosity of the tempered mass measured at a particular time point, for example TV3, as detailed below.

### Rheology of Chocolate

These textural properties of chocolate are determined, at least in part, by the rheological properties and/or particle size distribution of chocolate. Hence, controlling the rheological properties and/or particle size distribution of chocolate is important in order to control, for example consistently maintain or improve, the textural properties of the chocolate. However, the rheology of chocolate is complex, as detailed below, with significant interplay between variables. Furthermore, since the raw ingredients for chocolate are sourced naturally, further variability is introduced into the process of chocolate making, for example from batch-to-batch.

Chocolate is rheologically complex both above and below its broad melting range. Chocolate shows semi-solid behaviour at room temperature (20 to 25° C.). Chocolate melts into liquid form (strictly, a dense suspension of non-colloidal particles) at temperatures very close to oral temperature that is about 30 to 32° C. At room temperature, chocolate typically comprises about 10% liquid cocoa butter but this increases to 100% when the chocolate is fully molten above 35° C. Generally, chocolate contains about 70% of solid sugar, some cocoa solids and crystalline cocoa butter, which are dispersed in a continuous fat-phase cocoa butter. Different commercial chocolates can be found and are categorized into three primary groups that differ in content of cocoa solids, milk, and cocoa butter: dark chocolate, milk chocolate, and white chocolate. Cocoa butter is extracted from cocoa mass (ground cocoa beans) by pressing. Cocoa butter triglyceride is mainly formed from Palmitic (P), Stearic (S), and Oleic (O) fatty acids. Due to the presence of these triglycerides, cocoa butter is forms six different crystal structures with different melting behaviours. Chocolate crystallinity is greatly influenced by temperature treatment during processing, fat content, and triglycerides type. Usually, chocolates are made by pouring or extruding melt chocolate into a mould at temperature around 30° C. and cool down to retain the desired shape.

Rheologically, ‘liquid’ chocolates demonstrate non-Newtonian behaviour with a yield stress and plastic viscosity (stress to keep fluid in motion) with mild shear-thinning characteristics. Plastic viscosity may also be known as plasticity. The rheological behaviour of chocolate is influenced by fat content, emulsifier for example lecithin and/or polyglycerol polyricinoleate (PGPR) content, water or moisture content, conching time, crystallization, particle size distribution and temperature. Generally, a lower amount of fat results in higher yield stress values and/or higher viscosities. Surfactants further influence chocolate rheology. Addition of lecithin at low concentrations (below 3 wt. %) reduces both yield stress and viscosity. At 0.1-0.3 wt. %, lecithin and optionally PGPR, has a viscosity decreasing effect similar to that achieved by adding 1-3 wt. % cocoa butter. After around 5 wt. %, addition of more lecithin increases the yield stress while the plastic viscosity of the melt continues to drop. The addition of only a (very) small quantity of water is sufficient for the plastic viscosity and yield stress to increase significantly. Particle size distribution is another important parameter, which plays a role in chocolate rheological behaviour. Particularly, the size distribution of the solid particles greatly influences the rheological properties of chocolate: the larger the particles, the lower the yield value, and also the lower the viscosity, but to a lesser extent. Cocoa particle size varies from 15 to 30 μm. A bimodal particle size distribution with a small amount of fine and large amount of coarse particles may reduce the apparent viscosity. An increase in temperature above the melting point of fat will cause the plastic viscosity to decrease but the yield stress to rise. Conching mainly affects the yield stress, which decreases considerably particularly during the first hours of conching.

Chocolate having a relatively low plastic viscosity is easier to pump while chocolate having a relatively low yield stress pours more easily into moulds.

Liquid chocolate for producing solid moulded bars typically has a plastic viscosity in a range from about 1 to about 20 Pa·s and a yield stress in a range from about 10 to about 200 Pa. Liquid chocolate for enrobings typically has a plastic viscosity in a range from about 0.5 to about 2.5 Pa·s and a yield stress in a range from about 0 to about 20 Pa.

Particle sizes of chocolate and chocolate products strongly influence the mouth feel of the chocolate product-a very small particle size produces a “smooth” sensation in the mouth. To achieve the desired quality, not only the careful testing of final products, but also the monitoring of the production process is desirable. Particularly, the presence of particles larger 30 μm is a critical quality parameter for chocolate.

Semi-solid food fats, such as chocolate mass, typically include discrete crystalline particles in a liquid fat chocolate mass. There is some loose adhesion between the crystalline particles, which breaks down rapidly when the fat a shear stress is applied. This is referred herein as plasticity. Important factors in the context of measuring plasticity include (i) content of solids; (ii) size and shape of crystalline particles; (iii) persistence of crystalline particles nuclei when changing temperature; and (iv) mechanical working of the fats. Further, a texture of the chocolate mass is governed by the measured plasticity. The quality, which is in chocolate production also referred as “tenderness” is essentially dependent upon the measured plasticity. The maximum attainable degree of tenderness is often an important attribute for the best chocolate quality. Loss of moisture decreases plasticity. Thus, quantitative measurements of plasticity can be used for control of quality, in particular in large scale chocolate production lines. Plasticity can be measured in different ways. For example, the hardness of the fat at different temperatures can be measured, e.g. using a penetrometer, such as a Humboldt penetrometer. Plasticity measurement can also be used for controlling the effectiveness of tempering in solid chocolate mass based upon measurements with a sensitive penetrometer. Other measurements can also be used to measure surface hardness. Characteristics and quality of liquid chocolate mass critically depend upon viscosity, while the texture of the solidified chocolate mass is also governed by plasticity. However, the two properties are related. Specifications for different grades of the chocolate mass during the controlling of the production cycle can include the viscosity of the liquid chocolate mass determined at temperatures somewhat above its melting point, e.g. by a viscometer.

### Measurement of Rheological Properties

Measurement of the rheological properties of cocoa and chocolate products may be according to IOCCC (International Office of Cocoa, Chocolate, and Sugar Confectionery), “Viscosity of Cocoa and Chocolate Products (Analytical Method: 46),” CABISCO, Brussels, 2000.

Chocolate masses are melted in a water bath at 50° C. and thermostated for 20 min at 40° C. prior to the measurement in a rotational viscometer Model DV-III+ Digital Rheometer, Brookfield Engineering Laboratories (USA) with Spindle SC4-14, at 40° C. and within the 1-50 rpm range, according to the manufacturer's instructions. The viscometer is operated by using the Rheocalc V3.2 software which is also used for data analysis.

Rheological parameters: Casson plastic viscosity and Casson yield stress are calculated using NCA/CMA Casson model:

$$( 1 + a ) \sqrt{τ} = 2 \sqrt{{τ}_{0}} + ( 1 + a ) \sqrt{μ} D$$

where:
α is spindle outer radius/measurement cup inner radius ratio;
τ is shear stress (Pa);
τ₀ is yield stress (Pa);
μ is plastic viscosity (Pa·s); and
D is shear rate (s⁻¹).

Statistical analysis is performed using software Statistica 7.0.

Different important rheological models have been used to characterize the rheological behaviour of chocolate melts including the Herschel-Bulkley, Casson, Bingham, and Carreau models. Although the Casson is the recommended model by IOCCC (International Office of Cocoa, Chocolate, and Confectionery), it has been reported that it is not able to accurately characterize chocolate melt behaviour at low shear rates and other known models may be used.

In one example, the predicted viscosity of the tempered mass corresponds with a viscosity of the tempered mass measured at a particular time point, for example TV3.

What is important about tempered chocolate is how the viscosity changes over time when the tempered chocolate is held in pieces of process equipment, for example: a moulding line depositor hopper. Hence a method has been developed to assess the tempered chocolate over time, at the temperature it leaves the temperer (i.e. isothermally). This is done at a single shear rate by rotating a spindle in a large beaker of chocolate (i.e. an ‘infinite sea’ method) and measuring the viscosity at a number of time points.

For example, the viscosity of the tempered mass (e.g. tempered chocolate) may be measured at the temperature at which the tempered mass exits the temperer, for example at the end of the pipework where a sample valve may be located, for example at a temperature of about 29° C. Since the tempered viscosity typically changes with time, samples for measurement cannot stored and hence the viscosity is typically measured promptly—the temperature difference through the measurement time may be assumed to be negligible. The viscosity may be measured at a shear rate of 0.52 s⁻¹, for example.

For example, the viscosity of the tempered mass may be measured at successive time points, for example every 60 seconds, after stabilisation, whilst being maintained at the reheat temperature, so as to show a relationship between tempered mass viscosity and time. TVN, may be used to denote the measured viscosity of the tempered mass at different steps, as described below. Particularly, the inventors have identified that changes in TV3 or TV6 (depending on rheometer) may be significant and hence prediction of TV3 or TV6 may be important for controlling the tempering.

A typical rheometer program includes:
Step 1: 10 second rest
Step 2: 20 second measurement
Step 3: 1 minute 30 seconds rest
Step 4: 30 second measurement
Step 5: 1 minute 30 seconds rest
Step 6: 10 second measurement

Hence, for TVN, N denotes the step number. So, steps 2, 4 and 6 give measurement values TV2, TV4 and TV6, respectively while steps 1, 3 and 5 give a 0. However, some rheometers give 6 measurement values, depending on the program set up. Hence, TV2, TV4 and TV6 may be equivalent to TV1, TV2 and TV3, respectively, depending on the method set up.

### Tempering

The tempering (also known as controlled crystallization) comprises flowing the mass successively through the inlet, the crystallization stage to form crystals therein and the reheat stage to melt unstable crystals formed therein. Generally, tempering comprises thermal processing of a crystallisable mass under shear to selectively form crystals therein, typical using a temperer.

In more detail, tempering of a chocolate mass typically comprises:
i. heating a chocolate mass to a temperature in a range from 45° C. to 60° C. such that all the polymorphs melt;
ii. cooling the melted chocolate mass very slowly to a temperature in a range from 22° C. to 26° C., so as to initiate nucleation and growth of predominantly Form V polymorph crystals; and iii. reheating the cooled, recrystallised chocolate mass to a temperature in a range from 26° C. to 31° C., below the melting point of the Form V polymorph, so as to melt the undesirable and unstable Forms I to IV.

Generally, a chocolate temperer cools, crystallizes and reheats a molten chocolate mass to form a specific type of crystal. The chocolate mass is typically pumped into the bottom of the temperer through the inlet and traverses through a series of pans of the crystallization stage and the reheat stage, where it contacts heat exchange surfaces and is mixed by a central mixer in each pan, attached to a central shaft, which turns at a constant speed. The tempered chocolate mass is then pumped out of the temperer through an outlet. Optionally, a preheat stage may be included to ensure that all polymorphs have been melted before cooling the chocolate mass.

The crystallization stage may be preceded by a cooling stage (also known as a pre-cooling stage). The cooling stage typically uses water or propylene glycol solution as a heat transfer fluid to cool the chocolate mass. The water of the cooling water circuit has a temperature set point. Generally, the first stage cools the chocolate, and the second stage (crystallization stage) induces crystal formation. Depending on the temperer design, the same cooling water circuit can be used for these two stages, and the flow rate through the first stage and/or the second stage can be altered. Alternatively, these two stages may be operated as two independent stages. The chocolate that leaves the crystallization stage has a set point temperature. This set point can define the flow of water to a stage, depending on the design, and hence the rate of cooling of the chocolate mass.

The reheat stage typically also uses water or propylene glycol solution as a heat transfer fluid, in order to reheat the chocolate mass enough to melt out the unstable forms of crystals. This reheating water circuit is separated from the cooling water circuit. The pipework from the outlet of the temperer is also jacketed with water in order to maintain the outlet chocolate temperature, set to a similar temperature to that of the reheat stage water.

Tempering of a chocolate mass may also be achieved by seeding, for example by adding 0.2 to 2.0 wt. % Form V polymorph crystals to pre-cooled chocolate mass and cooling further, so as to grow Form V polymorph crystals on the seed crystals.

In one example, the tempering comprises:
heating the mass such that all polymorphs therein melt;
pumping the heated mass, optionally preheating the mass and flowing the mass successively through the inlet, optionally a cooling stage, the crystallization stage to form crystals therein, the reheat stage to melt unstable crystals formed therein and an outlet, wherein flowing the mass successively through optionally the cooling stage, the crystallization stage and/or the reheat stage comprises shearing, for example by stirring or mixing, the mass.

### Fat-Containing, Crystallisable Mass

It should be understood that the mass is a fat-containing, crystallisable mass, for example a chocolate mass. Other fat-containing, crystallisable masses are known, for example fat-based nougat (also known as truffle or praline) masses and fat-based crème masses. In one example, the fat-containing, crystallisable mass comprises and/or is a confectionery product.

In one example, the chocolate mass is formed from one or more of cocoa and/or a derivative thereof for example cocoa liquor, chocolate crumb and/or cocoa butter, milk powder, fat, sugar and/or an emulsifier and any combinations of these.

In one example, the chocolate mass comprises and/or is milk chocolate, family milk chocolate, dark chocolate or white chocolate, for example according to The Cocoa and Chocolate Products (England) Regulations 2003; Directive 2000/36/EC of the European Parliament and of the Council of 23 Jun. 2000 relating to cocoa and chocolate products intended for human consumption; US CFR Title 21 Food and Drugs, Chapter I, Subchapter B, Part 163, Subpart B Requirements for Specific Standardized Cacao Products; or equivalent. Milk chocolate typically comprises: milk (for example 14 wt. % minimum), sugar, cocoa butter and cocoa mass (for example, cocoa solids 25 wt. % minimum), optionally vegetable fat(s) (for example palm, shea), emulsifier(s) (for example E442, E476) and/or flavourings. Family milk chocolate typically comprises: milk solids (for example 20 wt. % minimum), sugar, cocoa butter and cocoa mass (for example, cocoa solids 20 wt. % minimum), optionally vegetable fat(s) (for example palm, shea), emulsifier(s) (for example E442, E476) and/or flavourings. Dark chocolate typically comprises cocoa mass, sugar, cocoa butter, optionally flavouring(s) and/or emulsifier(s). White chocolate typically comprises sugar, cocoa butter, milk, optionally emulsifier(s) and/or flavouring(s).

### Computer

The method is implemented, at least in part, by the computer including the processor and the memory. More generally, in one example, the method is implemented, at least in part, by a controller comprising a computer including a processor and a memory and/or a programmable logic controller (PLC). Other controllers are known.

In one example, predicting the temper level and/or the viscosity of the tempered mass using the model comprises predicting, by the computer, the temper level and/or the viscosity of the tempered mass using the model.

In one example, the memory is configured to store the model. In one example, the processor is configured to execute instructions, store in the memory, to implement the method according to the first aspect, for example, to predict the temper level and/or the viscosity of the tempered mass using the model.

### Predicting

The method comprises predicting the temper level and/or the viscosity of the tempered mass using the model. In this way, a predicted temper level and/or a predicted viscosity of the tempered mass may be estimated or forecast (i.e. predicted) using the model. The predicted temper level and/or the predicted viscosity of the tempered mass may be used to control the tempering, directly for example automatically, computationally, programmatically as described with respect to the second aspect and/or indirectly, for example by manually changing set points by a human operator. In this way, the tempering may be controlled in real-time, thereby improving tempering of the flowing mass (i.e. the current batch).

### Model

The method comprises predicting the temper level and/or the viscosity of the tempered mass using the model, wherein the model relates the temper level and/or the viscosity of the tempered mass to the one or more temperer process parameters.

It should be understood that the model is created by tempering sample masses. That is, the model is created using samples of masses, tempered according to different tempering conditions, as described below. In one example, the method comprises creating the model by sensing the one or more temperer process parameters of a plurality of sample masses, measuring the temper levels and/or the viscosities of the respective tempered sample masses and relating the sensed one or more temperer process parameters of the plurality of sample masses and the measured temper levels and/or viscosities of the respective tempered sample masses.

In one example, the model correlates the temper level and/or the viscosity of the tempered mass to the one or more temperer process parameters. In one example, the model comprises and/or is a multivariate statistical model, for example Partial Least Squares (PLS) or Recursive Least Squares (RLS).

In one example, predicting the temper level and/or the viscosity of the tempered mass using the model comprises predicting the temper level and the viscosity of the tempered mass using the model. Particularly, the inventors have identified that predicting the temper level, for example the recrystallisation temperature, and the viscosity of the tempered mass is important for chocolate masses comprising relatively high dairy contents, enabling improved control of the tempering of such chocolate masses.

In one example, the model relates the temper level and/or the viscosity of the tempered mass to one or more physical, chemical and/or rheological properties of the tempered mass. Physical properties include melting point, pH, colour, mechanical properties and particle size distribution. Chemical properties include composition, for example fat content and/or type, and polymorph forms present and may be characterised by spectroscopy, for example. Rheological properties include viscosity, flow behaviour index, consistency coefficient, hysteresis behaviour

In one example, the one or more physical, chemical and/or rheological properties of the tempered mass include an absorption spectrum and/or a viscosity.

### Temperer Process Parameters

The method comprises predicting the temper level and/or the viscosity of the tempered mass using the model, wherein the model relates the temper level and/or the viscosity of the tempered mass to the one or more temperer process parameters.

It should be understood that the one or more temperer process parameters (also known as temperer process variables) are sensed values, acquired from the tempering process, and hence of the mass and/or of the temperer during the tempering. The temperer process parameters are thus outputs and may be sensed using sensors; directly, for example by measurement, or indirectly, for example by calculation using a soft-sensor.

In one example, the one or more temperer process parameters include an inlet temperature, a crystallization stage temperature and/or a reheat stage temperature. Particularly, the inventors have identified that one or more of these temperatures, for example of the mass and/or heat exchange fluid temperatures of the crystallization stage and/or the reheat stage, may influence the temper level and/or the viscosity of the tempered mass.

In one example, the inlet temperature, the crystallization stage temperature and the reheat stage temperature comprise and/or are temperatures of the mass and/or heat exchange fluid temperatures of the crystallization stage and/or the reheat stage, for example an inlet mass temperature, a crystallization stage mass temperature, a reheat stage mass temperature, a crystallization stage heat exchange fluid temperature and/or a reheat stage heat exchange fluid temperature.

In one example, the one or more temperer process parameters include a crystallization stage mass temperature, a reheat stage mass temperature and a reheat stage heat exchange fluid temperature. Particularly, the inventors have identified that these temperatures may influence the temper level, for example a crystallization temperature of the tempered mass, and/or the viscosity of the tempered mass.

In one example, the one or more temperer process parameters include an inlet mass temperature and/or a crystallization stage heat exchange fluid temperature. Particularly, the inventors have identified that these temperatures may behave as disturbance variables. For example, if chocolate mass flows directly from a chocolate making conch, the chocolate mass may be relatively hotter while if the chocolate mass has been stored for some time, the chocolate mass may be relatively cooler. Such a difference in the inlet mass temperature may act to disturb the tempering.

In one example, the one or more temperer process parameters include an outlet temperature, for example sensed proximal an outlet and/or an outlet conduit for the tempered mass.

In one example, the outlet temperature comprises and/or is a temperature of the mass and/or a heat exchange fluid temperature.

In one example, the one or more temperer process parameters include an outlet heat exchange fluid temperature.

In one example, the one or more temperer process parameters include an inlet mass temperature, a crystallization stage mass temperature, a reheat stage mass temperature, a crystallization stage heat exchange fluid temperature, a reheat stage heat exchange fluid temperature and an outlet heat exchange fluid temperature.

In one example, the one or more temperer process parameters include a thoughput of the mass, for example in a range from 50 kg/hr to 20,000 kg/hr, preferably in a range from 1,000 kg/hr to 10,000 kg/hr, more preferably in a range from 3,000 kg/hr to 4,000 kg/hr, for example about 3,500 kg/hr. In one example, the thoughput of the mass is constant (i.e. fixed).

### Method of Controlling

The second aspect provides a method of controlling tempering of a fat-containing, crystallisable mass, for example a chocolate mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or temperer process parameters;
predicting a temper level and/or a viscosity of a tempered mass according to the first aspect using the sensed one or more temperer process parameters;
comparing the predicted temper level with a target temper level range and/or comparing the predicted viscosity with a target viscosity range; and
controlling one or more set points of temperer process parameters, based on a result of the comparing.

In this way, the tempering is controlled based on the predicted temper level and/or the predicted viscosity of the tempered mass in relation to the respective target ranges, directly for example automatically, computationally, programmatically. In this way, the tempering may be controlled in real-time, thereby improving tempering of the flowing mass (i.e. the current batch).

The fat-containing, crystallisable mass, the flowing, the inlet, the crystallization stage, the crystals, the reheat stage, the unstable crystals, the temperer process parameters, the temper level, the viscosity, the predicted temper level and/or the predicted viscosity may be as described with respect to the first aspect.

### Real-Time

In one example, the method comprises repeatedly, for example intermittently, periodically and/or continuously such as in real-time:
predicting the temper level and/or a viscosity of the tempered mass according to the first aspect using the sensed one or more temperer process parameters;
comparing the predicted temper level with the target temper level range and/or comparing the predicted viscosity with the target viscosity range; and
controlling one or more set points of temperer process parameters, based on the result of the comparing.

### Comparing

The method comprises comparing the predicted temper level with the target temper level range and/or comparing the predicted viscosity with the target viscosity range.

It should be understood that the target temper level range and the target viscosity range are desired, predetermined ranges of the temper level and the viscosity of the tempered mass, respectively. The respective ranges thus define upper and lower bound thresholds. The particular desired ranges may depend on the mass and/or subsequent processing of the tempered mass. Generally, a goal may be to maintain the temper level and/or the viscosity of the tempered mass within the respective target ranges. Hence, a result of the comparing may be whether the predicted temper level and/or the predicted viscosity are within the respective target ranges and if not, whether they are above or below and by how much. Additionally and/or alternatively, a result of the comparing may be a rate of change of the predicted temper level and/or the predicted viscosity. Additionally and/or alternatively, lower and/or bound thresholds may be predetermined. Generally, a goal may be to maintain the temper level and/or the viscosity of the tempered mass above and/or below the respective lower and/or bound thresholds.

In one example, a target crystallization temperature is in a range from 17° C. to 25° C., preferably in a range from 18° C. to 24° C., and/or a target crystallization temperature range is ±3° C., preferably ±2° C. For example, the target crystallization temperature may be 21.5° C. and the target crystallization temperature range may be 20° C. to 23.5° C. For example, the target crystallization temperature may be 19.5° C. and the target crystallization temperature range may be 18° C. to 21° C.

In one example, a target temper index is in a range from 3 to 7, preferably in a range from 3.5 to 6.5, more preferably in a range from 4 to 6 and/or a target temper index range is ±2, preferably ±1.5, more preferably ±1.

In one example, a target viscosity is in a range from 100 Pa s to 500 Pa s, preferably in a range from 110 Pa s to 450 Pa s, more preferably in a range from 135 Pa s to 350 Pa s and/or the target viscosity range is ±100 Pa s, preferably ±50 Pa s, more preferably ±25 Pa s or ±30%, preferably ±25%, more preferably ±25% of the target viscosity.

### Contrasting

In one example, the method comprises contrasting the predicted temper level (i.e. a value c.f. a range) with a target temper level (i.e. a value c.f. a range) and/or contrasting the predicted viscosity (i.e. a value c.f. a range) with a target viscosity (i.e. a value c.f. a range) and controlling the one or more set points of temperer process parameters, based on a result of the contrasting.

It should be understood that the target temper level and the target viscosity are desired, predetermined values of the temper level and the viscosity of the tempered mass, respectively. The particular desired values may depend on the mass and/or subsequent processing of the tempered mass. Generally, a goal may be to maintain the temper level and/or the viscosity of the tempered mass within a predetermined difference, above or below the respective target values. Hence, a result of the contrasting may be whether the predicted temper level and/or the predicted viscosity are above or below and by how much.

### Controlling

The method comprises controlling the one or more set points of temperer process parameters, based on a result of the comparing.

It should be understood that the set points are controllable, settable values of the temperer process parameters. It should be understood that these one or more temperer process parameters may be the same as or different from the sensed one or more temperer process parameters.

In one example, controlling one or more set points of temperer process parameters, based on the result of the comparing, comprises increasing or decreasing, for example by a predetermined amount or proportion, the one or more set points of temperer process parameters, for example based on whether the predicted temper level and/or the predicted viscosity are within the respective target ranges and if not, whether they are above or below and by how much and/or a rate of change of the predicted temper level and/or the predicted viscosity.

In one example, controlling the one or more set points of temperer process parameters comprises controlling one or more set points of an inlet temperature, a crystallization stage temperature and/or a reheat stage temperature.

In one example, controlling the one or more set points of the temperer process parameters comprises responsively adjusting respective flow rates (for example by adjusting pump speeds, mass flow controllers, adjustable valves) and/or temperatures (for example by heating or cooling) of heat exchange fluids of the crystallization stage and/or the reheat stage, so as to move towards the controlled set points, for example using a feedback controller such as a proportional-integral-derivative controller (PID controller).

In one example, controlling the one or more set points of the temperer process parameters comprises model predictive control (MPC). MPC is known.

### Temperer

The third aspect provides a temperer for tempering of a fat-containing, crystallisable mass, for example a chocolate mass, the temperer comprising:
an inlet, a crystallization stage and a reheat stage defining a flowpath there through for the mass;
a set of sensors for sensing one or more temperer process parameters; and
a computer, including a processor and a memory, configured to:
predict a temper level and/or a viscosity of the tempered mass using a model, wherein the model relates the temper level and/or the viscosity of the tempered mass to the sensed one or more temperer process parameters;
compare the predicted temper level with a target temper level range and/or compare the predicted viscosity with a target viscosity range; and
control one or more set points of the temperer process parameters of the inlet, the crystallization stage and/or the reheat stage, based on a result of the comparing.

The tempering, the fat-containing, crystallisable mass, the inlet, the crystallization stage, the reheat stage, the temperer process parameters, the temper level, the viscosity, the predicting, the predicted temper level, the predicted viscosity, the comparing, the target temper level range, the target viscosity range, the controlling and/or the one or more set points may be as described with respect to the first aspect and/or the second aspect. The computer may be configured to implement a method according to the first aspect and/or the second aspect. The temperer may be as described with respect to the first aspect and/or the second aspect.

In one example, the set of sensors includes one or more temperature sensors, for example for measuring temperatures of the mass and/or heat exchange fluids. In one example, the set of sensors includes a tempermeter, for measuring a temper index of the tempered mass. In one example, the set of sensors includes a viscometer, for measuring a viscosity of the tempered mass. In one example, the set of sensors includes an absorption spectrometer, for example inline, for measuring an absorption spectrum of the tempered mass.

Temperers are known. In one example, the temperer comprises pump for pumping the mass through the flowpath, a set of pans, having heat exchange surfaces, a set of corresponding mixers attached to a central shaft and a motor for rotating the shaft.

In one example, the crystallization stage is thermally coupled to a first heat exchanger circuit including a heat exchange fluid, for example water, one or more pumps, valves and heater/coolers.

In one example, the reheat stage is thermally coupled to a second heat exchanger circuit including a heat exchange fluid, for example water, one or more pumps, valves and heater/coolers.

In one example, the temperer comprises a cooling stage preceding the crystallization stage, optionally thermally coupled to the first heat exchanger circuit.

In one example, the temperer comprises an outlet and an outlet conduit fluidically coupled thereto. In one example, the outlet conduit is thermally coupled to a third heat exchanger circuit including a heat exchange fluid, for example water, one or more pumps, valves and heater/coolers.

### Causation Model

The fourth aspect provides a method of controlling tempering of a fat-containing, crystallisable mass, for example a chocolate mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or more temperer process parameters;
optimising a temper level and/or a viscosity of the tempered mass by controlling one or more set points of the temperer process parameters using a model of response dynamics of the tempering.

For example, one or more of the temperer process parameters (manipulated variables) and/or set points thereof may be individually stepped up and down to monitor the process dynamics and understand how the controlled variables of viscosity and/or level of temper are impacted. This enables causation models to be built which described how each process parameter impacts the temper level and/or the viscosity of the tempered mass and how process parameter impact each other. These causation models may be used to optimise the solution to achieve the best possible temper level and/or the viscosity of the tempered mass under the current process conditions and to predict how the dynamics of the process would impact control moves into the future time horizon. Set-points for PID controllers on the temperer may be updated periodically and/or frequently, for example every few minutes, to ensure the temperer remains in optimum control.

The tempering, the fat-containing, crystallisable mass, the chocolate mass, the computer, the flowing, the temperer, the inlet, the crystallization stage, the crystals, the reheat stage, the unstable crystals, the sensing, the one or more temperer process parameters, the temper level of the tempered mass, the viscosity of the tempered mass and/or the one or more set points of the temperer process parameters may be as described with respect to the first aspect, the second aspect and/or the third aspect.

In one example, the method comprises predicting the temper level and/or the viscosity of the tempered mass according to the first aspect.

In one example, the method comprises measuring the temper level and/or the viscosity of the tempered mass, for example as described with respect to the first aspect, the second aspect and/or the third aspect.

In one example, the model of response dynamics of the tempering comprises and/or is a causation model. Causation models are known.

In one example, the method comprises generating the model of response dynamics of the tempering.

In one example, generating the model of response dynamics of the tempering comprises modulating one or more of the temperer process parameters and/or set points thereof and monitoring the tempering, for example by individually, systematically, progressively and/or iteratively adjusting the one or more of the temperer process parameters and sensing the one or more temperer process parameters.

### Computer, Computer Program and Non-Transient Computer-Readable Storage Medium

The fifth aspect provides a computer comprising a processor and a memory configured to implement a method according to the first aspect, the second aspect and/or the fourth aspect.

The fifth aspect provides a computer program comprising instructions which, when executed by a computer comprising a processor and a memory, cause the computer to perform a method according to the first aspect, the second aspect and/or the fourth aspect.

The sixth aspect provides a non-transient computer-readable storage medium comprising instructions which, when executed by a computer comprising a processor and a memory, cause the computer to perform a method according to the first aspect, the second aspect and/or the fourth aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a temperer according to an exemplary embodiment;

FIG. 2A is a graph of observed temper index versus predicted temper index for a model for an exemplary embodiment; FIG. 2B is a graph of observed crystallisation temperature versus predicted crystallisation temperature for the model; FIG. 2C is a graph of observed TV2 (labelled Viscosity 2) versus predicted TV2 versus for the model; FIG. 2D is a graph of observed TV4 (labelled Viscosity 4) versus predicted TV4 versus for the model; FIG. 2E is a graph of observed TV6 (labelled Viscosity 6) versus predicted TV6 versus for the model; and FIG. 2F is a bar chart of coefficients for the model;

FIG. 3A is a bar chart of R² and Q² for temper index, crystallisation temperature, TV2 (labelled Viscosity 2), TV4 (labelled Viscosity 4) and TV6 (labelled Viscosity 6) for a model for an exemplary embodiment; FIG. 3B is a bar chart of R² and Q² for temper index, crystallisation temperature, TV2 (labelled Viscosity 2), TV4 (labelled Viscosity 4) and TV6 (labelled Viscosity 6) for a model for an exemplary embodiment; and FIG. 3C is a bar chart of R² and Q² for temper index, crystallisation temperature, TV2 (labelled Viscosity 2), TV4 (labelled Viscosity 4) and TV6 (labelled Viscosity 6) for a model for an exemplary embodiment;

FIG. 4 schematically depicts a method according to an exemplary embodiment; and

FIG. 5 schematically depicts a method according to an exemplary embodiment.

### DETAILED DESCRIPTION OF THE DRAWINGS

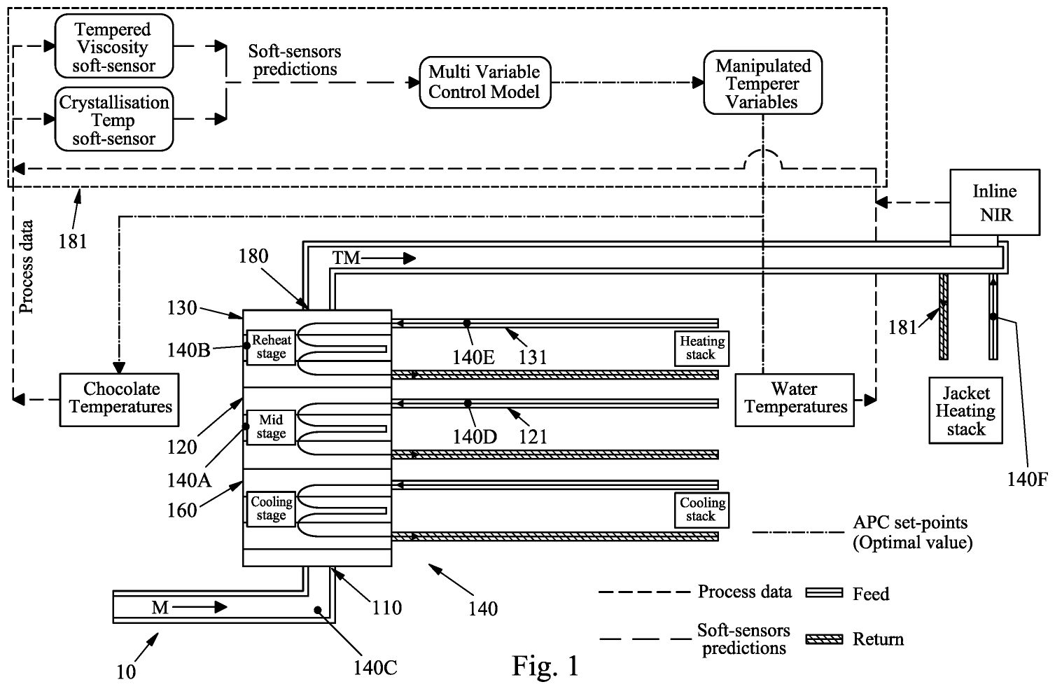

FIG. 1 schematically depicts a temperer 10 according to an exemplary embodiment.

The temperer 10 is for tempering of a fat-containing, crystallisable mass M, particularly a chocolate mass.

The temperer 10 comprises an inlet 110, a crystallization stage 120 (labelled mid stage) and a reheat stage 130 (labelled reheat stage) defining a flowpath (denoted by arrows) therethrough for the mass M.

The temperer 10 comprises a set of sensors 140 for sensing one or more temperer process parameters. In this example, the set of sensors 140 includes a first temperature sensor 140A for sensing a crystallization stage mass temperature, a second temperature sensor 140B for sensing a reheat stage mass temperature, a third temperature sensor 140C for sensing an inlet mass temperature, a fourth temperature sensor 140D for sensing a crystallization stage heat exchange fluid temperature, a fifth temperature sensor 140E for sensing a reheat stage heat exchange fluid temperature and a sixth temperature sensor 140F for sensing an outlet conduit heat exchange fluid temperature. In this example, the set of sensors includes an inline NIR absorption spectrometer for measuring an absorption spectrum of the tempered mass.

The temperer 10 comprises a computer 150, including a processor and a memory (not shown), configured to: predict a temper level and/or a viscosity of the tempered mass TM using a model, wherein the model relates the temper level and/or the viscosity of the tempered mass to the sensed one or more temperer process parameters; compare the predicted temper level with a target temper level range and/or compare the predicted viscosity with a target viscosity range; and control one or more set points of the temperer process parameters of the inlet, the crystallization stage and/or the reheat stage, based on a result of the comparing.

Temperers are known. In this example, the temperer 10 comprises pump (not shown) for pumping the mass M through the flowpath, a set of pans (not shown), having heat exchange surfaces, a set of corresponding mixers (not shown) attached to a central shaft (not shown) and a motor (not shown) for rotating the shaft.

In this example, the temperer 10 is a modified Sollich Turbotemper®e Typ TE flex, modified by including additional pans. Generally, known temperers may be adapted according to provide the subject matter of the aspects provided herein.

In this example, the crystallization stage 120 comprises a first heat exchanger circuit 121 including a heat exchange fluid, particularly water, one or more pumps (not shown), valves (not shown) and heater/coolers (not shown).

In this example, the reheat stage 130 comprises a second heat exchanger circuit 131 including a heat exchange fluid, particularly water, one or more pumps (not shown), valves (not shown) and heater/coolers (not shown).

In this example, the temperer 10 comprises a cooling stage 160 (labelled cooling stage) preceding the crystallization stage 120, thermally coupled to the first heat exchanger circuit 121.

In this example, the temperer 10 comprises an outlet 170 and an outlet conduit 180 fluidically coupled thereto. In this example, the outlet conduit 180 is thermally coupled to a third heat exchanger circuit 181 including a heat exchange fluid, particularly water, one or more pumps (not shown), valves (not shown) and heater/coolers (not shown).

Typical set points will vary depending on the type of chocolate. For milk chocolate, typical set points are:
Crystallisation stage chocolate temperature: 27.7 C
Reheat stage chocolate temperature: 30.5 C

The invention relates to the method of controlling the process of tempering chocolate. The invention measures the crystallization temperature and viscosity of chocolate in real time, and react to changes in these quality variables in order to keep them on target and/or within specification.

The invention includes the development of inferential tools to predict, in real time, the control variables—Temperature of Crystallization, Temper Index and Tempered Viscosity. Soft sensors or Virtual Online Analysers will be used for this purpose. Soft-sensors are tools used for measuring one or more process or quality attributes that are calculated within a software from a variety of inputs variables by using statistical treatment such Partial Least Squares (PLS) or Recursive Least Squares (RLS).

The invention includes the development of five soft sensors:
1. Temperature of Crystallation
2. Tempered Viscosity 1
3. Tempered Viscosity 2
4. Tempered Viscosity 3
5. Temper Index

These control variables are all highly affected by the temperatures in the temperer set up. The manipulated variables in the temperer that are to be used as a soft sensor input for the control variables are:
Cold stage chocolate temperature
Cold stage water temperature
Hot stage water temperaure
Tempered pipework water temperature

Other operational variables are also considered as disturbances, including but not limited to the temperer feed temperature, the feed tank temperature, the feed to depositor temperature and the temperer shaft current.

A ProFoss Inline NIR can be calibrated for the control variables, and used to strengthen the soft sensor prediction; using the spectral data as an input.

Following the real time measurement of the control variables, as explained above, Model Predictive Control (MPC) has been used in this invention, to control the process and reduce the variability in the chocolate tempered viscosity and ensure the chocolate temperature of crystallization is within specification. MPC is an advanced method of process control, where a set of constraints is satisfied and finite time-horizon optimization is achieved by predicting future events and take control actions accordingly.

In this context, at least one of the manipulated variables described above, such as cold stage chocolate temperature, are adjusted to predicted MPC optimal set points, to keep the process within specification (Crystallization Temperature) and reduce tempered viscosity variability.

Conventionally, the process is manually controlled by operators when out of specification Crystallization Temperatures are detected by samples taken before the moulding line, enrober or other chocolate forming process. Adjustments are consequently applied to the temperer, but usually only one manipulated variable is altered, when it is known that all four manipulated variables described above can affect the control variables. Tempered viscosity is not measured on the line, however, the tempered viscosity effects the rheological behaviour of the chocolate when it is processed later in the line. If the chocolate rheology was controlled, the line would react better to disturbances and stoppages.

The described invention instead, provides a holistic approach of real time process control, which is automated and accurate.

### Model

Two examples of a model were used to determine the final model according to an exemplary embodiment. The first was a pilot plant study, the second a production plant application.

### Pilot Plant Model

This was done on a basic pilot plant temperer, with a throughput between 40-100 kg/hr.

Models were created by systematically by changing temperer process parameters and measuring the crystallization temperature and tempered viscosity for two chocolate masses, S12 and M15.

The final model for the pilot plant was built on 189 observations from 95 M15 sample and 94 S12 samples. Twelve (12) components were used to fit the model, as described below with respect to the pilot plant.

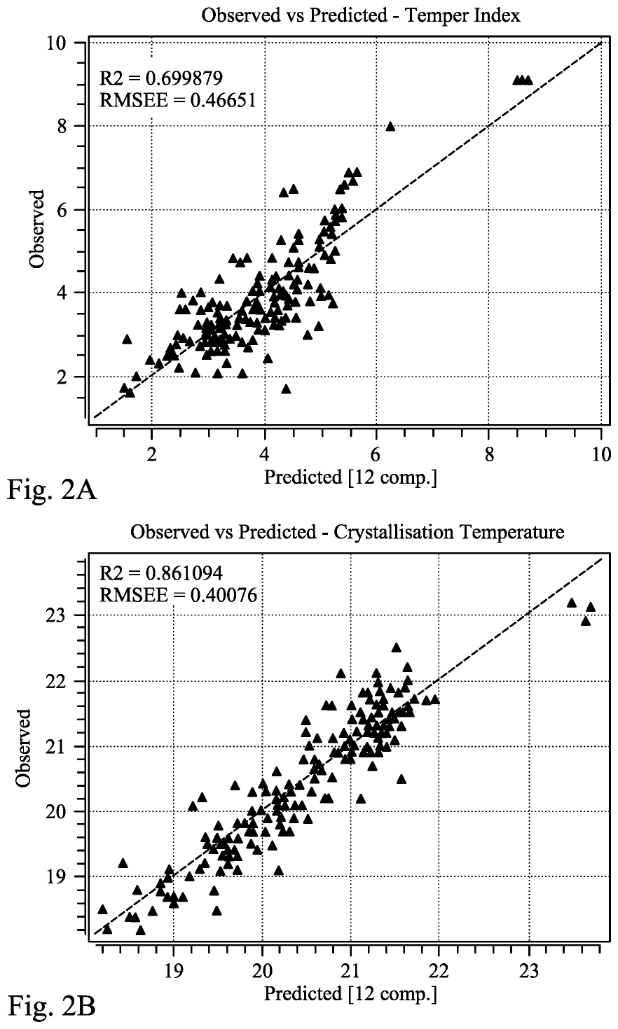

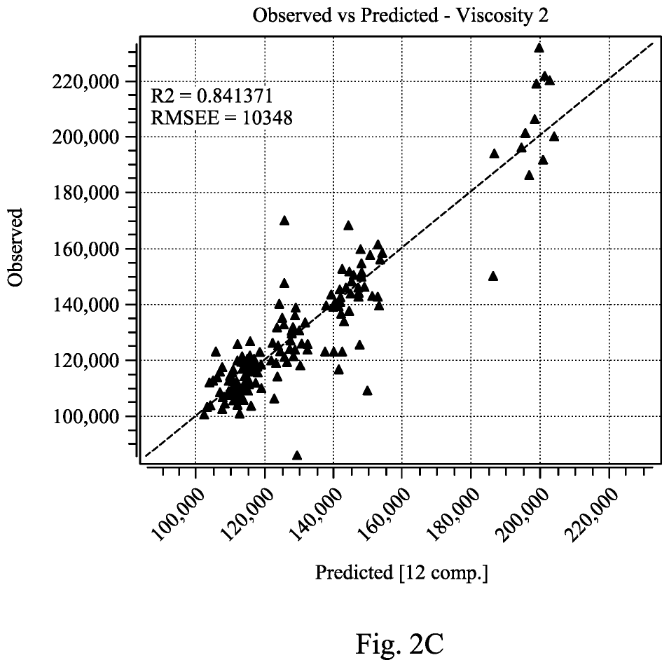

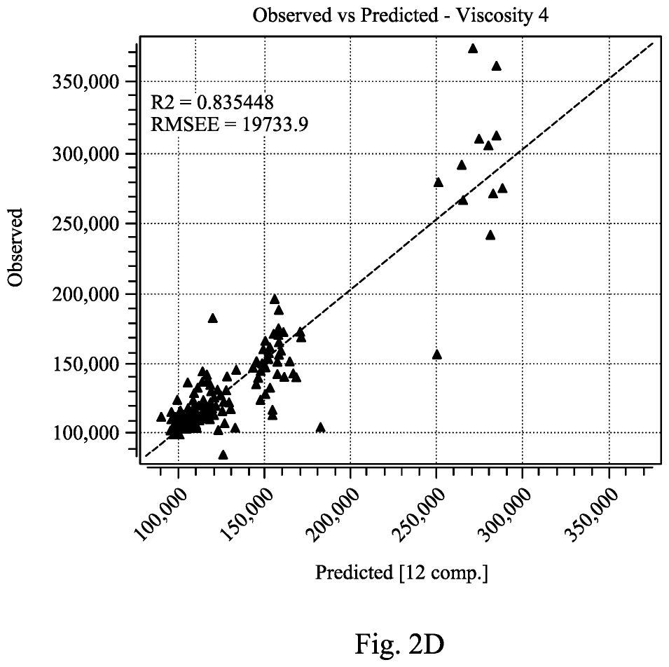

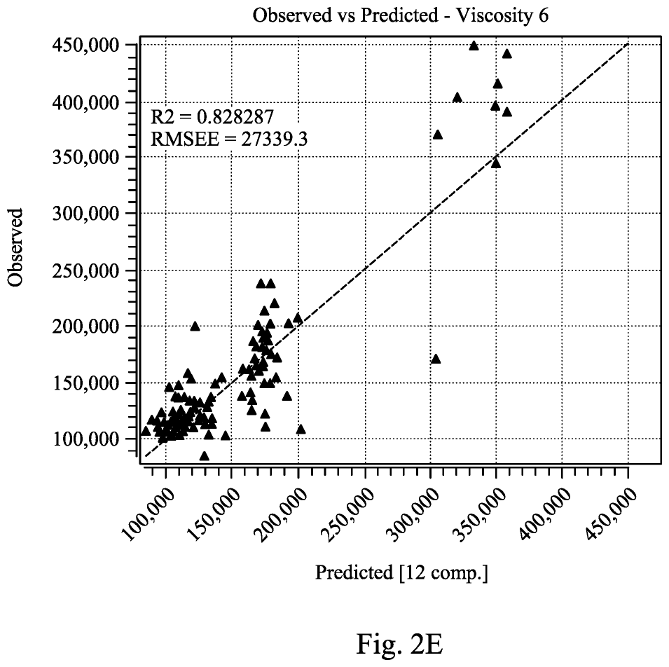

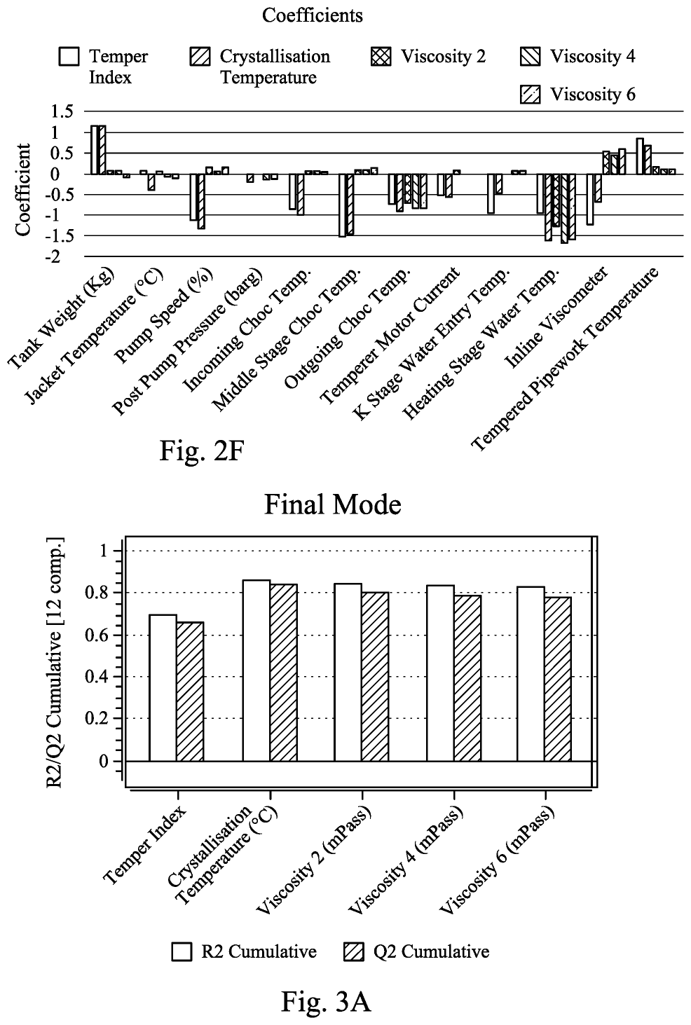

FIGS. 2A to 2F show the model fit for temper index, crystallization temperature, TV2, TV4 and TV6 respectively, for S12 and M15 chocolate for a pilot plant.

FIG. 2F is a bar chart of coefficients with respect to temper index, crystallisation temperature, TV2, TV4 and TV6, for the model, for twelve (12) components:
1. Incoming chocolate temperature;
2. middle stage chocolate temperature;
3. outgoing chocolate temperature;
4. heating stage water temperature;
5. middle (K) stage water entry temperature;
6. tank weight;
7. jacket temperature;
8. pump speed;
9. post pump pressure;
10. temperer motor current;
11. inline viscometer; and
12. tempered pipework temperature.

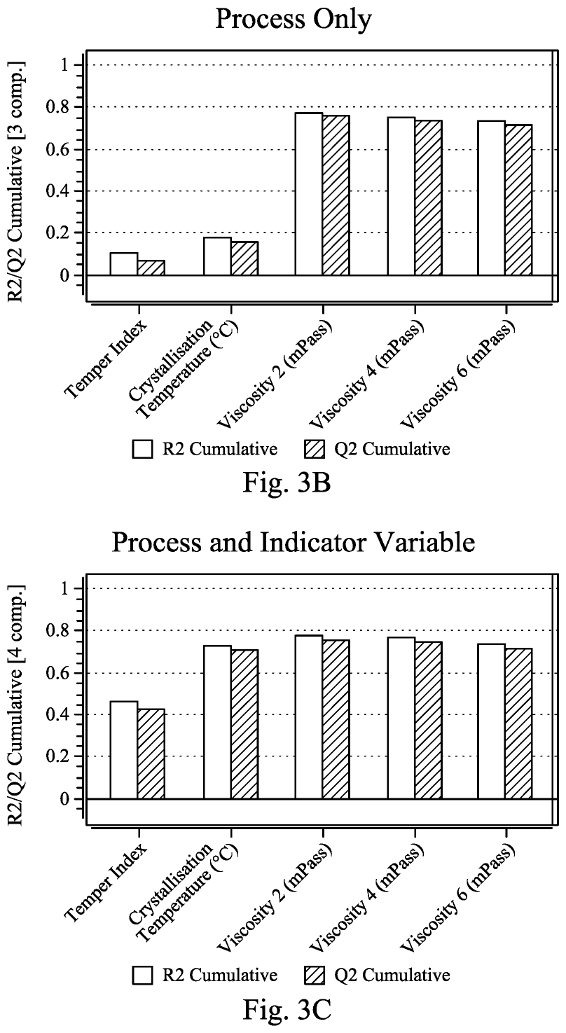

FIGS. 3A to 3C show R² and Q² for temper index, crystallization temperature and TV2, TV4 and TV6 for models for exemplary embodiments, as summarized in Table 2.

TABLE 2
R² and Q² for temper index, crystallization temperature
and TV2, TV4 and TV6 for models for exemplary
embodiments for the pilot plant.

| | | | Process | | Process and | |
|---|---|---|---|---|---|---|
| Quality | Final Model | | only Model | | IV Model | |
| variable | R² | Q² | R² | Q² | R² | Q² |
| Temper Index | 0.70 | 0.66 | 0.10 | 0.07 | 0.45 | 0.44 |
| Crystallization | 0.86 | 0.84 | 0.17 | 0.15 | 0.71 | 0.70 |
| Temperature | | | | | | |
| Viscosity 2 | 0.84 | 0.80 | 0.76 | 0.75 | 0.76 | 0.74 |
| (TV2) | | | | | | |
| Viscosity 4 | 0.84 | 0.79 | 0.74 | 0.73 | 0.76 | 0.74 |
| (TV4) | | | | | | |
| Viscosity 6 | 0.83 | 0.78 | 0.72 | 0.70 | 0.74 | 0.71 |
| (TV6) | | | | | | |

There were 3 types of models built for the pilot plant. The Process only Model includes temperer process parameters only. The Final Model includes temperer process parameters and NIR data. The Process and IV Model includes an indicator variable (IV), particularly a binary variable to distinguish the M15 samples and the S12 samples (1 and 0 respectively), to ensure the model is picking up the difference between the M15 and S12 chocolates.

The NIR data (i.e. included in the Final Model) may be used to distinguish different chocolates and/or may be used to improve fit, for example compared with the Process only Model and the Process and IV Model. The NIR data improves the fit of the temper index and crystallization temperature significantly and improves also the fit of TV2 to TV6.

The findings from the pilot plant study were used as a basis for the production plant study. The pilot plant study showed that:
Multiple variables effect the output of the temperer, including temper level and tempered viscosity.
Models can be built to predict the temper level and tempered viscosity.
The use of NIR data to improve the model should be explored.
throughput (pump speed) was one of the most important variables; therefore in the production plant study, throughput was fixed.

### Production Model

The production model used a different computer software, measurement methods were refined, and the temperer is better controlled than the basic pilot plant temperers.

A model was created by systematically changing temperer process parameters and measuring the crystallization temperature and tempered viscosity for two chocolate masses, S12 and M15, as summarized in Table 3, for a production plant.

TABLE 3
Design of Experiment step tests for model creation.

| | | MVs | | | |
|---|---|---|---|---|---|
| | | Cooling | | | |
| | | stage | Cooling | Heating | Hot water to |
| Step | | chocolate | stage water | stage water | tempered |
| test | | temperature | temperature | temperature | pipework |
| number | Product | (° C.) | (° C.) | (° C.) | temperature (° C.) |
| S1 | S12 | 28 (initial) | 14.0 | 31.0 | 30.0 |
| | | 28.2 | 14.0 | 31.0 | 30.0 |
| | | 27.7 | 14.0 | 31.0 | 30.0 |
| | | 28.2 | 14.0 | 31.0 | 30.0 |
| | | 27.7 | 14.0 | 31.0 | 30.0 |
| | | 28.0 | 14.0 | 31.0 | 30.0 |
| S2 | S12 | 28.0 | 14.0 | 31 (initial) | 30.0 |
| | | 28.0 | 14.0 | 31.2 | 30.0 |
| | | 28.0 | 14.0 | 30.7 | 30.0 |
| | | 28.0 | 14.0 | 31.2 | 30.0 |
| | | 28.0 | 14.0 | 30.7 | 30.0 |
| | | 28.0 | 14.0 | 31.0 | 30.0 |
| S3 | S12 | 28.0 | 14.0 | 31.0 | 30.0 (initial) |
| | | 28.0 | 14.0 | 31.0 | 30.5 |
| | | 28.0 | 14.0 | 31.0 | 29.5 |
| | | 28.0 | 14.0 | 31.0 | 30.0 |
| S4 | S12 | 28 (initial) | 14.0 (initial) | 31.0 | 30.0 |
| | | 28.2 | 14.2 | 31.0 | 30.0 |
| | | 28.2 | 13.8 | 31.0 | 30.0 |
| | | 27.8 | 13.8 | 31.0 | 30.0 |
| | | 27.8 | 14.2 | 31.0 | 30.0 |
| | | 28.0 | 14.0 | 31.0 | 30.0 |
| M1 | M15 | 27.4 (initial) | 14.0 | 31.0 | 30.0 |
| | | 27.6 | 14.0 | 31.0 | 30.0 |
| | | 27.1 | 14.0 | 31.0 | 30.0 |
| | | 27.6 | 14.0 | 31.0 | |
| | | 27.1 | 14.0 | 31.0 | |
| | | 27.4 | 14.0 | 31.0 | 30.0 |
| M2 | M15 | 28.0 | 14.0 | 31 (initial) | 30.0 |
| | | 28.0 | 14.0 | 31.2 | 30.0 |
| | | 28.0 | 14.0 | 30.7 | 30.0 |
| | | | | 31.2 | |
| | | | | 30.7 | |
| | | 28.0 | 14.0 | 31.0 | 30.0 |
| M3 | | 28.0 | 14.0 | 31.0 | 30.0 (initial) |
| | M15 | 28.0 | 14.0 | 31.0 | 30.5 |
| | | 28.0 | 14.0 | 31.0 | 29.5 |
| | | 28.0 | 14.0 | 31.0 | 30.0 |
| M4 | M15 | 27.4 (initial) | 14.0 (initial) | 31.0 | 30.0 |
| | | 27.6 | 14.2 | 31.0 | 30.0 |
| | | 27.6 | 13.8 | 31.0 | 30.0 |
| | | 27.2 | 13.8 | 31.0 | 30.0 |
| | | 27.2 | 14.2 | 31.0 | 30.0 |
| | | 27.4 | 14.0 | 31.0 | 30.0 |

Typically, the throughput of the chocolate mass is about 3500 kg/hr (M15=3520 kg/hr; S12=3750 kg/hr).

The models to predict the crystallization temperature and tempered viscosity used the following temperer process components, amongst others:
1. Hot stage chocolate temperature
2. Chocolate feed temperature
3. Chocolate cold stage temperature

Table 4 summarises the initial standard deviations (SD) of the predictions for crystallization temperature (CT) and tempered viscosity (TV3) for the M15 and S12 chocolates. These are initial modelling results from the Design of Experiment, which are due to be tested live in production.

TABLE 4
Model prediction standard deviations (SD) for
crystallization temperature (CT) and tempered
viscosity (TV3for the M15 and S12 chocolates.

| | CT SD | TV3 SD |
|---|---|---|
| | (° C.) | (Pa s) |
| S12 | 0.20 | 6.47 |
| M15 | 0.32 | 36.07 |

Table 5 summarises the controlled variables (CV) for the M15 and S12 chocolates.

TABLE 5
Control strategy for M15 and S12 chocolates.

| S12. Control: | M15. Control: |
|---|---|
| 1. Crystallisation Temperature | 1. Crystallisation Temperature |
| 2. Tempered Viscosity within a range | 2. Hot Stage Chocolate Temperature |
| 3. Hot Stage Chocolate Temperature | 3. Tempered Viscosity within a range |

Table 5 shows the weighted control strategy for each chocolate. The variables in Table 5 are being controlled, they are called the control variables (CVs). The CVs are predicted by models using the temperer process components, described previously, as inputs.

The CVs can be controlled by the variables on the process that can be manipulated and in turn, affect the CVs value; these are manipulated variables (MVs). The list of MVs on the temperer process are as follows:
Cold stage chocolate temperature
Cold stage water temperature
Hot stage chocolate temperature
Hot stage water temperature
Tempered pipework jacket water temperature

It should be understood that the MVs are not limited to these and may be dependent on the particular temperer, for example. For example, rather than changing the hot stage chocolate temperature directly, the hot stage water temperature may be instead changed so as to changing the hot stage chocolate temperature indirectly.

Table 6 summarises the controlled variables (CVs) targets and ranges, including target crystallization temperatures and target tempered viscosity ranges for the M15 and S12 chocolates.

TABLE 6
Control Variable (CV) Targets and ranges. Target crystallization
temperatures (CT) and target tempered viscosity (TV3)
ranges for the M15 and S12 chocolates.

| | | TV3 |
|---|---|---|
| | CT TARGET (° C.) | (Pa s) |
| S12 | 21.5 | 110-160 |
| M15 | 19.5 | 250-450 |

The controller is able to manipulate the temperer's MVs, in order to control and optimise the CVs within range and at a target.

### Method of Predicting

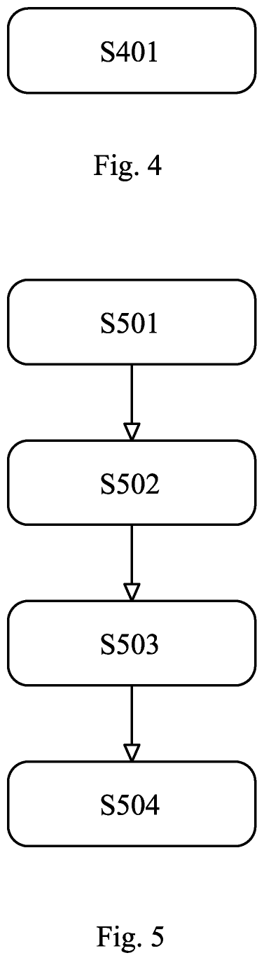

FIG. 4 schematically depicts a method according to an exemplary embodiment. Particularly, FIG. 4 schematically depicts a method of predicting a temper level and/or a viscosity of a tempered mass, provided by tempering of a fat-containing, crystallisable mass, for example a chocolate mass, by flowing the mass successively through a temperer comprising an inlet, a crystallization stage to form crystals therein and a reheat stage to melt unstable crystals formed therein, according to the first aspect.

At S401, the method comprises predicting the temper level and/or the viscosity of the tempered mass using a model, wherein the model relates the temper level and/or the viscosity of the tempered mass to one or more temperer process parameters.

The method may include any of the steps as described with respect to the first aspect.

### Method of Controlling

FIG. 5 schematically depicts a method according to an exemplary embodiment. Particularly, FIG. 5 schematically depicts a method of controlling tempering of a fat-containing, crystallisable mass, for example a chocolate mass, the method implemented, at least in part, by a computer including a processor and a memory, according to the second aspect.

At S501, the method comprises flowing the mass successively through a temperer comprising an inlet, a crystallization stage to form crystals therein and a reheat stage to melt unstable crystals formed therein and sensing one or temperer process parameters.

At S502, the method comprises predicting a temper level and/or a viscosity of a tempered mass according to the first aspect using the sensed one or more temperer process parameters.

At S503, the method comprises comparing the predicted temper level with a target temper level range and/or comparing the predicted viscosity with a target viscosity range.

At S504, the method comprises controlling one or more set points of temperer process parameters, based on a result of the comparing.

The method may include any of the steps as described with respect to the first aspect and/or the second aspect.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A method of predicting a temper level and/or a viscosity of a tempered mass provided by tempering of a fat-containing, crystallisable mass by flowing the mass successively through a temperer comprising an inlet, a crystallization stage to form crystals therein and a reheat stage to melt unstable crystals formed therein, the method implemented, at least in part, by a computer including a processor and a memory, the method comprising:
predicting the temper level and/or the viscosity of the tempered mass using a model, wherein the model relates the temper level and/or the viscosity of the tempered mass to one or more temperer process parameters.

2. The method according to claim 1, wherein the one or more temperer process parameters include an inlet temperature, a crystallization stage temperature and/or a reheat stage temperature.

3. The method according to claim 2, wherein the inlet temperature, the crystallization stage temperature and the reheat stage temperature comprise and/or are temperatures of the mass and/or heat exchange fluid temperatures of the crystallization stage and/or the reheat stage, for example an inlet mass temperature, a crystallization stage mass temperature, a reheat stage mass temperature, a crystallization stage heat exchange fluid temperature and/or a reheat stage heat exchange fluid temperature.

4. The method according to claim 2, wherein the one or more temperer process parameters include an outlet temperature.

5. The method according to claim 4, wherein the outlet temperature comprises and/or is a temperature of the mass and/or a heat exchange fluid temperature.

6. The method according to claim 1, wherein the temper level comprises and/or is a temper index and/or a crystallization temperature of the tempered mass.

7. The method according to claim 1, wherein the model relates the temper level and/or the viscosity of the tempered mass to one or more physical, chemical and/or rheological properties of the tempered mass.

8. The method according to claim 7, wherein the one or more physical, chemical and/or rheological properties of the tempered mass include an absorption spectrum and/or a viscosity.

9. A method of controlling tempering of a fat-containing, crystallisable mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or more temperer process parameters;
predicting a temper level and/or a viscosity of a tempered mass according to claim 1 using the sensed one or more temperer process parameters;
comparing the predicted temper level with a target temper level range and/or comparing the predicted viscosity with a target viscosity range; and
controlling one or more set points of the temperer process parameters, based on a result of the comparing.

10. The method according to claim 9, wherein controlling the one or more set points of temperer process parameters set points of the temperer process parameters comprises controlling one or more set points of an inlet temperature, a crystallization stage temperature and/or a reheat stage temperature.

11. The method according to claim 9, comprising contrasting the predicted temper level with a target temper level and/or contrasting the predicted viscosity with a target viscosity and controlling the one or more set points of temperer process parameters, based on a result of the contrasting.

12. The method according to claim 9, wherein controlling the one or more set points of the temperer process parameters comprises responsively adjusting respective flow rates and/or temperatures of heat exchange fluids of the crystallization stage and/or the reheat stage.

13. The method according to claim 9, wherein the mass comprises and/or is a chocolate mass.

14. A temperer for tempering of a fat-containing, crystallisable mass, for example a chocolate mass, the temperer comprising:
an inlet, a crystallization stage and a reheat stage defining a flowpath therethrough for the mass;
a set of sensors for sensing one or more temperer process parameters; and
a computer, including a processor and a memory, configured to:
predict a temper level and/or a viscosity of the tempered mass using a model, wherein the model relates the temper level and/or the viscosity of the tempered mass to the sensed one or more temperer process parameters;
compare the predicted temper level with a target temper level range and/or compare the predicted viscosity with a target viscosity range; and
control one or more set points of the temperer process parameters of the inlet, the crystallization stage and/or the reheat stage, based on a result of the comparing.

15. A method of controlling tempering of a fat-containing, crystallisable mass, the method implemented, at least in part, by a computer including a processor and a memory, the method comprising:
flowing the mass successively through a temperer comprising an inlet, a crystallization stage to form crystals therein and a reheat stage to melt unstable crystals formed therein and sensing one or more temperer process parameters;
optimising a temper level and/or a viscosity of the tempered mass by controlling one or more set points of the temperer process parameters using a model of response dynamics of the tempering.

16. The method according to claim 15, comprising predicting the temper level and/or the viscosity of the tempered mass using a model, wherein the model relates the temper level and/or the viscosity of the tempered mass to one or more temperer process parameters.

17. The method according to claim 15, comprising measuring the temper level and/or the viscosity of the tempered mass.

18. The method according to claim 15, wherein the model of response dynamics of the tempering comprises and/or is a causation model.

19. The method according to claim 15, comprising generating the model of response dynamics of the tempering.

20. The method according to claim 19, wherein generating the model of response dynamics of the tempering comprises modulating one or more of the temperer process parameters and monitoring the tempering.
